(19) United States
(12) Patent Application Publication
(10) Pub. No.: US 2024/0347802 A1
(43) Pub. Date: Oct. 17, 2024

(54) METHOD FOR RECOVERING METAL FROM ELECTRODE ACTIVE MATERIALS

(71) Applicant: Board of Regents of the Nevada System of Higher Education, on behalf of the University of Nevada, Reno, NV (US)

(72) Inventors: Vaidyanathan Subramanian, Reno, NV (US); Prichard Tembo, Reno, NV (US)

(73) Assignee: Board of Regents of the Nevada System of Higher Education, on behalf of the University of Nevada, Reno, NV (US)

(21) Appl. No.: 18/636,880

(22) Filed: Apr. 16, 2024

Related U.S. Application Data
(60) Provisional application No. 63/459,834, filed on Apr. 17, 2023.

(51) Int. Cl. H01M 10/54; C22B 3/44; C22B 7/00; C22B 26/12

(52) U.S. Cl. CPC H01M 10/54; C22B 3/44; C22B 7/007; C22B 26/12

(57) ABSTRACT

Disclosed herein are embodiments of a method for recovering metal from electrode active materials. In particular embodiments, the method comprises recovering at least one metal from a lithium-ion battery (LIB), wherein a lixiviant is used without the need for an extraneous reducing agent. In particular aspects of the disclosure, a particular solid-to-liquid ratio of the electrode active material and lixiviant is used to promote selective recovery of lithium. In yet other aspects, reaction temperature and/or stirring speeds can be used to improve selective lithium recovery and efficiency using lixiviants disclosed herein.

### CROSS REFERENCE TO RELATED APPLICATION

This application claims the benefit of and priority to the earlier filing date of U.S. Provisional Application No. 63/459,834, filed Apr. 17, 2023, which is incorporated herein by reference in its entirety.

### FIELD

The present disclosure concerns a method for recovering metals from electrode active materials, and compositions and/or combinations associated with the method.

### BACKGROUND

There is a projected increase in demand for energy storage technologies due to the interest in alternative energy resources because of the urgent consideration for the environment. Moreover, high energy storage options rely substantially on lithium-based technologies and thus there has been significant consumption of lithium, which is only going to increase. For example, technological advancements in portable devices and electric transportation rely on energy storage technology using lithium as the platform, such as lithium batteries and lithium-ion batteries, because of their high energy density and the fact that they are long-lasting and less harmful to the environment. Methods for recovering and reusing lithium has been of interest because of this increased demand for lithium-based technologies. Recovering lithium is also of paramount importance from a sustainability robust supply chain standpoint. Furthermore, because of the urgent consideration for the environment, methods for recovering and reusing lithium should reduce the pollution generated and the energy demand required by such methods. Accordingly, there is a need in the art for sustainable new methods of recycling energy storage materials, particularly those using lithium, that require less energy and generate less pollution.

### SUMMARY

Disclosed herein is a method, comprising: combining (i) a solid comprising an electrode active material and (ii) a liquid comprising a lixiviant to form a reaction mixture having a solid-to-liquid (S/L) ratio ranging from an amount greater than 0 g/L to an amount of 20 g/L; heating the reaction mixture; stirring the reaction mixture; and isolating a pregnant leach liquor from the reaction mixture, wherein the pregnant leach liquor comprises at least one metal.

Also disclosed herein is a method, comprising: combining a lithium-battery electrode active material and a lixiviant to provide a reaction mixture; heating the reaction mixture at a temperature ranging from 25° C. to 70° C.; and recovering lithium from the lithium-battery electrode active material in an amount of at least 60%, wherein the reaction mixture does not comprise an extraneous reducing agent.

Also disclosed is a method, comprising: discharging a lithium ion battery (LIB); dismantling the LIB to form a dismantled LIB; combining the dismantled LIB with NaOH to promote aluminum dissolution to thereby obtain an electrode active material; leaching at least one metal from the electrode active material to thereby obtain a pregnant leaching liquor, the leaching comprising combining a solid and liquid to form a reaction mixture having a S/L ratio ranging from an amount greater than 0 g/L to an amount of 20 g/L, wherein the solid comprises an electrode active material, and wherein the liquid comprises at least one lixiviant; heating the reaction mixture; stirring the reaction mixture; and filtering the reaction mixture to separate any solid residue from the reaction mixture.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 is a schematic illustrating the different stages of a hydrometallurgical treatment process flow involving treating lithium-containing electrode materials (e.g., lithium-ion batteries) with a lixiviant to isolate lithium from the lithium-containing electrode materials according to aspects of the present disclosure.

FIG. 2 is a schematic diagram illustrating at least certain steps of a method according to aspects of the present disclosure, wherein addition of an extraneous reducing agent is not needed for desired Li recovery.

FIG. 3 is a schematic illustration of an unreacted electrode active material illustrating the shrinking core model when treating an unreacted electrode active material.

FIG. 4 is a pictorial depiction of an electrode active material core after lixiviant application illustrating the shrinking core model.

FIG. 5 is a graph of lithium recovery (%) as a function of solid-to-liquid ratio (g/L) showing results obtained from analyzing a reaction mixture obtained from a method disclosed herein using HBr as the lixiviant and a solid-to-liquid ratio ranging from 6 g/L to 14 g/L.

FIG. 6 is a graph of lithium recovery (%) as a function of solid-to-liquid ratio (g/L) showing results obtained from analyzing a reaction mixture obtained from a method disclosed herein using HI as the lixiviant and a solid-to-liquid ratio ranging from 6 g/L to 14 g/L.

FIG. 7 is a graph of lithium recovery (%) as a function of time (minutes) showing results obtained from analyzing a reaction mixture obtained from a method disclosed herein, wherein heating at a temperature ranging from 25° C. to 70° C. was used, along with 1 M HBr as the lixiviant.

FIG. 8 is a graph of lithium recovery (%) as a function of time (minutes) showing results obtained from analyzing a reaction mixture obtained from a method disclosed herein, wherein heating at a temperature ranging from 25° C. to 70° C. was used, along with 2 M HBr as the lixiviant.

FIG. 9 is a graph of lithium recovery (%) as a function of time (minutes) showing results obtained from analyzing a reaction mixture obtained from a method disclosed herein, wherein heating at a temperature ranging from 25° C. to 70° C. was used, along with 3 M HBr as the lixiviant.

FIG. 10 is a graph of lithium recovery (%) as a function of time (minutes) showing results obtained from analyzing a reaction mixture obtained from a method disclosed herein, wherein by heating at a temperature ranging from 25° C. to 70° C. was used, along with 1 M HI as the lixiviant.

FIG. 11 is a graph of lithium recovery (%) as a function of time (minutes) showing results obtained from analyzing a reaction mixture obtained from a method disclosed herein, wherein by heating at a temperature ranging from 25° C. to 70° C. was used, along with 1.5 M HI as the lixiviant.

FIG. 12 is a graph of lithium recovery (%) as a function of time (minutes) showing results obtained from analyzing a reaction mixture obtained from a method disclosed herein, wherein by heating at a temperature ranging from 25° C. to 70° C. was used, along with 2 M HI as the lixiviant.

FIG. 13 is a bar graph of the recovery (%), time (minutes), and temperature (° C.) as a function of the lixiviant used showing results for (i) a method using H₂SO₄ or HCl as the lixiviant, both with and without an extraneous reducing agent (H₂O₂); and (ii) a method according to aspects of the disclosure using HBr and HI as the lixiviant without an extraneous reducing agent; the graph shows superior recovery for the method using HBr and HI without an extraneous reducing agent wherein significantly less time was needed and lower temperature where utilized to achieve a 70% lithium recovery.

FIG. 14 is a scanning electron micrograph (SEM) showing the secondary electron (SE) image of an untreated cathode active material core illustrating a larger sized grains when compared to a treated cathode active material core (see FIG. 15).

FIG. 15 is an SE image of a cathode active material core after the lixiviant application illustrating a smaller sized grains after lixiviant application relative to the untreated cathode active material core (see FIG. 14).

FIG. 16 is a backscattered electron (BSE) image of an untreated cathode active material core illustrating a generally uniform bright contrast when compared to a cathode active material core after lixiviant application (see FIG. 17) as there are more heavier elements uniformly distributed in the untreated cathode active material core.

FIG. 17 is the BSE image of a cathode active material core after lixiviant application illustrating non-uniform and dark contrast when compared to an untreated cathode active material core (see FIG. 16), which is a result of the heavier metals leaching out by lixiviant application.

FIG. 18 is a graph showing the kinetic data fit of k′ as a function of t′ obtained from analyzing a reaction mixture obtained from a method disclosed herein wherein heating at a temperature ranging from 25° C. to 70° C. was used in combination with HBr as the lixiviant (where k′=kt, k ln t and t′=t, ln t, corresponding to the respective model equation).

FIG. 19 is a graph showing the kinetic data fit of k′ as a function of t′ obtained from analyzing a reaction mixture obtained from a method disclosed herein, wherein heating at a temperature ranging from 25° C. to 70° C. was used in combination with HI as the lixiviant (where k′=kt, k ln t and t′=t, ln t, corresponding to the respective model equation).

FIG. 20 is a graph showing the kinetic data fit of ln k as a function of 1000/T (K⁻¹) obtained from analyzing a reaction mixture obtained from a method disclosed herein, wherein heating at a temperature ranging from 25° C. to 70° C. was used in combination with HBr as the lixiviant (where k′=kt, k ln t and t′=t, ln t, corresponding to the respective model equation).

FIG. 21 is a graph showing the kinetic data fit of k′ as a function of t′ obtained from analyzing a reaction mixture obtained from a method disclosed herein, wherein heating at a temperature ranging from 25° C. to 70° C. was used in combination with HI as the lixiviant (where k′=kt, k ln t and t′=t, ln t, corresponding to the respective model equation).

FIG. 22 is a graph showing the kinetic data fit of k′ as a function of t′ obtained from Equations 3-9 analyzing a reaction mixture obtained from a method disclosed herein, wherein heating at a temperature of 40° C. was used in combination with 3 M HBr as the lixiviant (where k′=kt, k ln t and t′=t, ln t, corresponding to the respective model equation).

FIG. 23 is a graph showing the kinetic data fit of k′ as a function of t′ obtained from Equation 3 analyzing a reaction mixture obtained from a method disclosed herein, wherein heating at a temperature ranging from 25° C. to 40° C. was used in combination with 3 M HBr as the lixiviant (where k′=kt, k ln t and t′=t, ln t, corresponding to the respective model equation).

FIG. 24 is a graph showing the kinetic data fit of k′ as a function of t′ obtained from Equations 3-9 analyzing a reaction mixture obtained from a method disclosed herein, wherein heating at a temperature of 40° C. was used in combination with 1.5 M HI as the lixiviant (where k′=kt, k ln t and t′=t, ln t, corresponding to the respective model equation)

FIG. 25 is a graph showing the kinetic data fit of k′ as a function of t′ obtained from Equation 4 analyzing a reaction mixture obtained from a method disclosed herein, wherein heating at a temperature ranging from 25° C. to 40° C. was used in combination with 3 M HI as the lixiviant (where k′=kt, k ln t and t′=t, ln t, corresponding to the respective model equation).

FIG. 26 is a graph of Ni, Co, and Mn recovery (%) as a function of time (minutes) showing results obtained from analyzing a reaction mixture obtained from a method disclosed herein using HBr as the lixiviant.

FIG. 27 is a graph of Ni, Co, and Mn recovery (%) as a function of time (minutes) showing results obtained from analyzing a reaction mixture obtained from a method disclosed herein using Hi as the lixiviant.

### DETAILED DESCRIPTION

### I. OVERVIEW OF TERMS

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

The following terms and definitions are provided:

Extraneous Reducing Agent: A chemical species that is a different chemical entity from any lixiviant according to aspects of the present disclosure. Exemplary extraneous reducing agents can include, but are not limited to, hydrogen peroxide (H₂O₂) and sodium bisulfite (NaHSO₃). Hydrogen bromide (or “HBr”) and hydrogen iodide (or “HI”) are not considered extraneous reducing agents when used in the context of the present disclosure.

Leaching: The dissolution of an element or compound contained in an electrode active material using a lixiviant according to the present disclosure.

Lixiviant: A liquid medium used to extract a desired element or compound from an electrode active material. In some aspects of the present disclosure, the lixiviant is not, or is other than, HCl, HNO₃, H₂SO₄, or a combination thereof.

Pregnant Leach Liquor: A composition obtained from the recovery of metals from source materials (e.g., metallurgical wastes, mineral ores and/or concentrates, spent batteries with liquid or solid electrolytes, spent catalysts, and the like). In some aspects of the present disclosure, leaching is employed prior to forming the pregnant leach liquor to dissolve or cause the leaching of certain metal component(s) into the aqueous phase.

Solid to Liquid (S/L) Ratio: The mass of solids that comes in contact with a given volume of lixiviant.

### II. INTRODUCTION

There has been intense research into energy storage technologies to fully leverage renewable energy. Energy storage technologies using lithium as a platform, such as lithium batteries (LB's) and lithium-ion batteries (LIB's), offer a high energy density, rapid startup, easily configurable based for use in gravimetric/volumetric energy density scales, are long lasting, and are environmentally friendly. Moreover, there has been significant research into energy storage technologies using lithium as a platform, and thus has made such energy storage technologies cost effective. Therefore, there is an increased demand for lithium leading to a need for recovering and reusing lithium.

Mechano-chemical, pyrometallurgical, and hydrometallurgical procedures can be used to recycle LIB technologies. Mechano-chemical procedures are associated with comminution operations that result in mechanically induced changes in the material that consequently influence the material chemical, structural, and physical properties. Through the combinations of mechanical forces such as impact, friction, and collision, a portion of the applied mechanical energy is converted into internal energy, which improves the material chemical reaction activity and thus change the material physiochemical properties. During mechano-chemical treatment, the chemical reaction, polymorphic transformations, and bond breakage all result in an increase in reaction activity and a decrease in activation energy. Pyrometallurgical procedures utilize substantially elevated temperatures for the selective extraction and separation of metals or other compounds. Pyrometallurgical procedures produce negligible to no liquid waste and thus allow for the large-scale up processing of materials. However, the pyrometallurgical procedures result in pollutant generation and a high energy demand (higher than other competing methods). In contrast, hydrometallurgical procedures result in less pollutant generation and operate with a lower energy demand, amendable to involving “green chemicals” and hence are a much more sustainable approach. Therefore, hydrometallurgical procedures can be used in the recovery and recycling of lithium from secondary sources such as spent lithium-ion batteries. Nevertheless, conventional hydrometallurgical procedures have their own associated drawbacks.

Conventionally, leaching cathode active materials comprises using at least one acid and an extraneous reducing agent to accelerate the leaching kinetics and improve cathode metal recoveries. For example, acids such as nitric (HNO₃), sulfuric (H₂SO₄) and hydrochloric (HCl) acid typically require the use of an extraneous reducing agent, such as hydrogen peroxide (H₂O₂) or sodium bisulfite (NaHSO₃) to facilitate effective leaching. HNO₃ requires large amounts of reducing agents to increase the leaching efficiency and release poisonous gases such as oxides of nitrogen (e.g., NOₓ). The high cost of HCl, along with the volatility, corrosion issues, and poisonous gas emissions in the form of chlorine gas (Cl₂), make HCl an undesirable lixiviant for large scale operations. HCl is also used in the production of other chemicals driving up its price as a raw material. The most widely adopted acid/reducing agent combination is H₂SO₄/H₂O₂ because the acid directly dissolves the metal constituents from the cathode active material and the reducing agent lowers the metal oxidation states, and thus aids the dissolution process. H₂SO₄, however, requires using the extraneous reducing agent, H₂O₂, to convert metal ions to favorable valency states. Moreover, elevated temperatures, for example between 60° C. to 80° C., are required for optimal leaching with this conventional approach using H₂SO₄/H₂O₂.

The present disclosure includes a novel method for recovering metals from electrode active materials. In certain aspects of the present disclosure, the method can be used to selectively leach lithium from such materials, including electrode active materials (e.g., cathode and/or anode materials). The method utilizes a lixiviant without having to use an extraneous reducing agent. Moreover, in some aspects of the disclosed method, a solid-to-liquid (S/L) ratio can be controlled so as to provide selective leaching at levels superior to conventional inorganic acids and that provide the ability to treat more solid material per given volume of lixiviant, lending the method to large-scale operations. In some aspects of the disclosure, the method can be performed under conditions (e.g., temperatures and/or time parameters) that provide superior yields and product selectively compared with conventional methods.

### III. METHOD EMBODIMENTS

Aspects of the present disclosure are directed to a method for treating lithium-containing electrode active materials to isolate metals or other materials contained therein. In some aspects of the present disclosure, the method comprises combining (i) a solid material comprising an electrode active material and (ii) a liquid material comprising at least one lixiviant to form a reaction mixture having a desired solid-to-liquid (S/L) ratio. The method further comprises heating the reaction mixture, stirring the reaction mixture, and isolating a pregnant leach liquor from the reaction mixture, wherein the pregnant leach liquor comprises at least one metal. In some aspects of the disclosure, the S/L ratio ranges from an amount greater than 0 g/L to an amount of 20 g/L. In particular aspects of the disclosure, the method utilizes fewer steps and/or lower temperatures compared to conventional methods and thus can provide a less complex method for isolating lithium.

In particular aspects of the present disclosure, the solid material may be obtained from a spent LIB. The spend LIB can be discharged and dismantled and then exposed to a base (e.g., NaOH) for aluminum dissolution to obtain an electrode active material. The electrode active material is then subjected to a method aspect of the present disclosure so as to leach at least one metal from the electrode active material, thereby providing a pregnant leach liquor comprising the at least one metal. In some aspects of the disclosure, a reaction mixture obtained from combining the electrode active material with the lixiviant can be filtered to separate any solid residue from the reaction mixture to provide the pregnant leaching liquor.

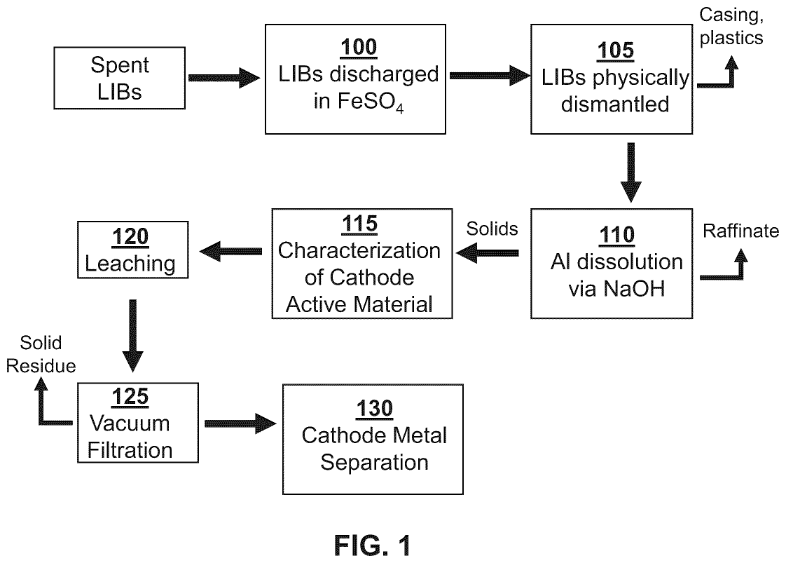

FIG. 1 illustrates a process according to aspects of the present disclosure, wherein LIBs are discharged in FeSO₄ (step 100) for 24 hours and then LIBs are physically dismantled (step 105), for example by removing casing, plastics, etc. Subsequent aluminum dissolution via NaOH (15%) (step 110) can be conducted to obtain the cathode active material by removing the raffinate (mainly Al). The solids comprising the electrode active material can be characterized to determine the elemental composition (step 115). Then, a leaching method according to the present disclosure can be conducted (e.g., process 120), followed by vacuum filtration (step 125) thereby removing the solid residue to form a pregnant leaching liquor. In some aspects of the disclosure, a further step of cathode metal separation can be conducted (step 130).

In particular aspects of the disclosure, the electrode active material may comprise spent LIBs and hence the electrode active material may comprise a lithium-containing material with one or more other metal ions, such as Ni, Mn, Co, Al, and Fe in any ratios in combination with oxygen. In some such aspects, the spent LIB's may comprise LiCoO₂, LiFePO₄, LiNiO₂, LiMnO₂O₄, LiNi_{X}Co_{y}Al_{z}O₂, and LiNiₓCo_{z}Mn_{y}O₂. In one exemplary aspect, the electrode active material comprises LiNiCoMnO₂.

While conventional leaching methods require an extraneous reducing agent, the presently disclosed method avoids using an extraneous reducing agent to provide selective leaching at improved levels. Specifically, conventional leaching methods provide mineral acids such as nitric (HNO₃), sulfuric (H₂SO₄) and hydrochloric (HCl) acid to a mixture for leaching, which require an extraneous reducing agent, such as H₂O₂ or NaHSO₃, for Li recovery in the pregnant leach liquor to metal separation. On the other hand, the method of present disclosure does not require an extraneous reducing agent in addition to a lixiviant during the leaching process.

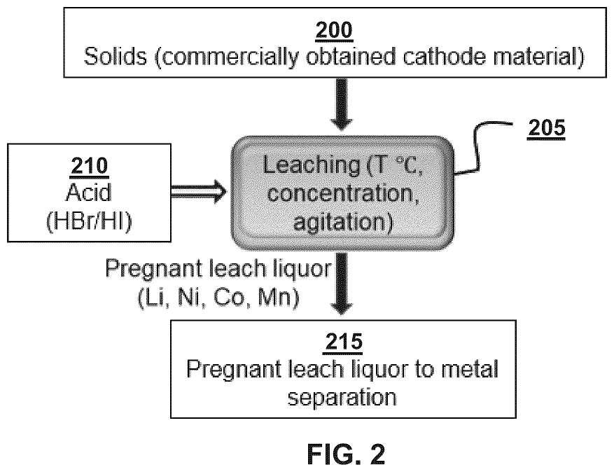

In some aspects of the disclosure, the lixiviant may comprise a strong acid. In some aspects, the lixiviant of the present method may have a more negative pKa value than acids used in conventional methods. In some aspects of the disclosure, the lixiviant may have a pKa value that is more negative than −8, such as a pKa from ranging from −12 to −8, such as −10 to −8. In some particular aspects of the disclosure, the pKa of the lixiviant can be −9 or −10. Furthermore, in contrast to the conventional methods of leaching cathode active materials, the method disclosed herein comprises the application of a lixiviant without an extraneous reducing agent. FIG. 2 illustrates at least some differences between a conventional leaching process and the method according to aspects of the present disclosure. As shown in FIG. 2, solid materials, such as electrode active material 200, can be combined for leaching (step 205) with a lixiviant 210 having a pKa of −9 (e.g., HBr) or a pKa of −10 (e.g., HI), to form pregnant leach liquor to metal separation (step 215). By avoiding using extraneous reducing agents, aspects of the present disclosure can significantly decrease the cost and complexity of the leaching process. Furthermore, lixiviants according to aspects of the present disclosure have superior operational considerations as they can lower the operational temperature and have greater kinetic efficiency. Additionally, the lixiviants of the present disclosure result in simpler waste treatment and have beneficial environmental implications as compared to the conventional methods that require an extraneous reducing agent.

In aspects of the present disclosure, the method may further comprise determining the elemental composition of the solid electrode active material to obtain a S/L ratio to achieve a particular level of leaching. In some aspects, the S/L ratio can be determined and controlled so as to leach a desired metal at a particular level. In some aspects of the disclosure, the S/L ratio used in aspects of the presently disclosed method may range from an amount greater than 0 g/L to an amount of 50 g/L, such as from an amount greater than 0 g/L to an amount of 20 g/L, or from 5 g/L to 20 g/L, or from 5 g/L to 15 g/L. In aspects of the present disclosure, the S/L ratio can be used to tune the leaching operation such that amounts of lixiviant available to leach the desired metal from the electrode active material can be controlled so as to avoid excess amounts of the lixiviant. In one exemplary aspect of the disclosure, the S/L ratio is 9 g/L. In another exemplary aspect, the S/L ratio is 12 g/L. In yet another exemplary aspect, the S/L ratio is 9 g/L when using HBr. In another exemplary aspect, the S/L ratio is 12 g/L when using HI.

In particular aspects of the present disclosure, the leaching reaction in a hydrohalic acid medium can be expressed with Equation 1:

$$2 {LiMO}_{2 ( s )} + 8 {HX}_{( aq )} ↔ 2 {LiX}_{( aq )} + 2 {MX}_{2 ( aq )} + 4 {H}_{2} {O}_{( l )} + {X}_{2 ( aq )} . \qquad ( Equation 1 )$$

wherein, X is Br or I; and M is Ni, Mn, Co, or a combination thereof. It was determined that as lixiviant concentration increases, so did the concentration of H⁺, and thus it was determined that lixiviant concentration can be controlled to better facilitate improved lithium recovery.

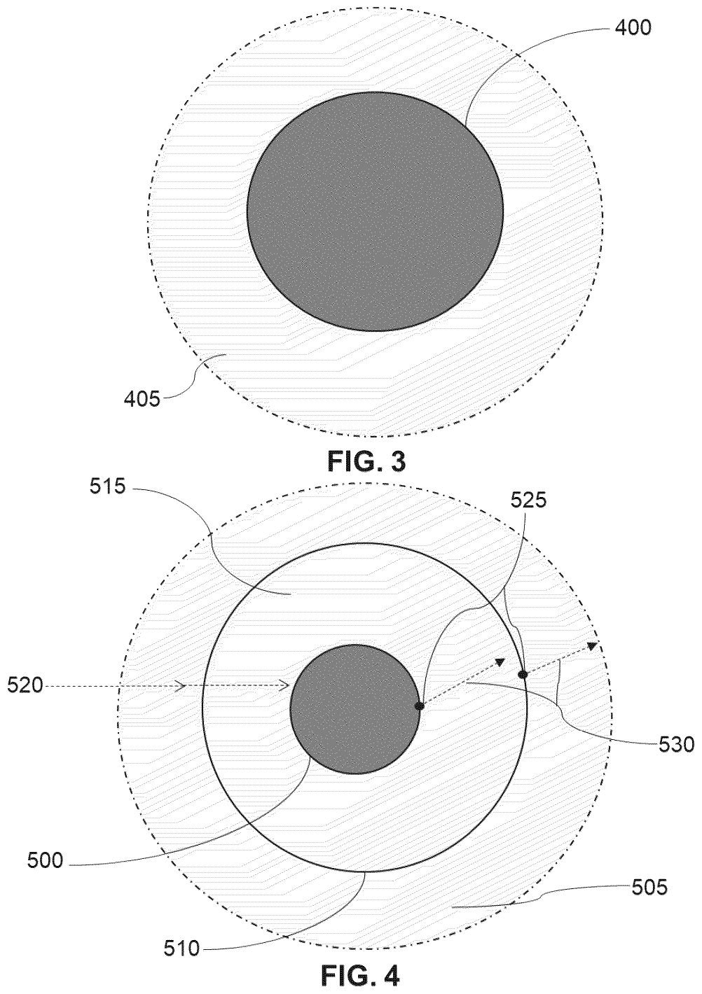

Without being limited to a single theory, the shrinking core model may offer mechanistic insights into the leaching process, which essentially divides the leaching reaction into the following processes: diffusion of lixiviant through the fluid-solid interface; diffusion of lixiviant molecules to the unreacted core surface through the fluid-solid interface and adsorption of the lixiviant molecules by unreacted solid; reaction of adsorbed lixiviant molecules with unreacted solid and product release; diffusion of reaction product to the solid-fluid interface through the reaction product ash layer; and diffusion of reaction product into the fluid. A pictorial depiction of the shrinking core model is illustrated in FIGS. 3 and 4. FIG. 3 illustrates an unreacted core 400 and fluid film 405. FIG. 4 illustrates the shrinking core model when treating an unreacted core 500 depicting the fluid film 505, electrode active material powder particle 510, reaction product layer 515, lixiviant diffusion 520, surface reactions 525, and the diffusion of products 530.

In some aspects, the lixiviant has a concentration ranging from a concentration greater than 0 M to a concentration of 5 M, such as from 0.5 M to 4 M, or 0.5 M to 3 M, or 0.5 M to 2 M, or 0.5 M to 1 M. In some particular aspects of the present disclosure, the lixiviant is HBr having a concentration ranging from 0.5 M to 3 M, such as 1 M to 3 M, or 0.5 M, 1 M, 2 M, or 3 M. In particular aspects of the present disclosure, the lixiviant is HI having a concentration ranging from 0.5 M to 2 M, such as 1 M to 2 M, or 0.5 M, 1 M, 1.5 M or 2 M. In some aspects, lower concentrations of the lixiviant (e.g., concentrations below 1 M) can be used in combination with a temperature above ambient temperature, such as greater than 35° C. or greater than 40° C.

The method of the present disclosure comprises heating the mixture at a temperature ranging from a temperature greater than 20° C. to a temperature of 80° C., such as from 25° C. to 70° C., or from 35° C. to 70° C., or from 45° C. to 70° C., or from 55° C. to 70° C. In some aspects of the present disclosure, increasing the temperature can facilitate increasing the rate constant and thus can increase the ability to recover more Li at temperatures of the present disclosure without having to increase lixiviant concentration.

In particular aspects of the disclosure, the mixture can be heated for a time period ranging from a time period greater than 0 minutes to a time period of 0 minutes, such as from greater than 0 to 55 minutes, from greater than 0 minutes to 50 minutes, from greater than 0 minutes to 45 minutes, from greater than 0 minutes to 40 minutes, from greater than 0 minutes to 35 minutes, from greater than 0 minutes to 30 minutes, from greater than 0 minutes to 25 minutes, from greater than 0 minutes to 20 minutes, from greater than 0 minutes to 15 minutes, or from greater than 0 minutes to 10 minutes.

In aspects, the method may provide a recovery of Li at a percentage that exceeds 40%. In some aspects of the present disclosure, Li can be recovered at a percentage ranging from 50% to 100%, such as from 50% to 95%, or 55% to 95%, or 60% to 95%, or 65% to 95%, or 70% to 95%, or 75% to 95%, or 80% to 95%, or 85% to 95%, or 90% to 95%, with some aspects providing yields of 55%, 60%, 65%, 70%, 75%, 80%, 85%, 90%, or 95%.

In some aspects of the disclosure, within the possible element space in the LIB (e.g., Ni, Co, Fe, Al, and/or Mn) the electrode active material may further comprise (in addition to Li) Ni, Co, and/or Mn. In some such aspects, the method may provide a recovery of such materials that exceeds 40%. In particular aspects of the present disclosure, Ni can be recovered at a percentage ranging from 60% to 80%. In particular aspects of the present disclosure, Mn can be recovered at a percentage ranging from 50% to 80%. In particular aspects of the present disclosure, Co can be recovered at a percentage ranging from 45% to 55%.

### IV. OVERVIEW OF SEVERAL EMBODIMENTS

Disclosed herein are embodiments of a method comprising: combining (i) a solid comprising an electrode active material and (ii) a liquid comprising a lixiviant to form a reaction mixture having a solid-to-liquid (S/L) ratio ranging from an amount greater than 0 g/L to an amount of 20 g/L; heating the reaction mixture; stirring the reaction mixture; and isolating a pregnant leach liquor from the reaction mixture, wherein the pregnant leach liquor comprises at least one metal.

In any or all of the above embodiments, the lixiviant has a pKa ranging from −12 to −8.

In any or all of the above embodiments, the lixiviant is HBr.

In any or all of the above embodiments, HBr has a concentration ranging from a concentration greater than 0 M to a concentration of 4M.

In any or all of the above embodiments, the S/L ratio is 9 g/L.

In any or all of the above embodiments, the lixiviant is HI.

In any or all of the above embodiments, the HI has a concentration ranging from a concentration greater than 0 M to a concentration of 3 M.

In any or all of the above embodiments, the S/L ratio is 12 g/L.

In any or all of the above embodiments, the electrode active material comprises a lithium-containing material.

In any or all of the above embodiments, the lithium containing material further comprises Co, O, Fe, P, Ni, Mn, Al, or any combination thereof.

In any or all of the above embodiments, the at least one metal is an alkali metal.

In any or all of the above embodiments, the alkali metal is Li.

In any or all of the above embodiments, the at least one metal is a transition metal.

In any or all of the above embodiments, the transitional metal is Ni, Co, Mn, or any combination thereof.

In any or all of the above embodiments, heating the reaction mixture comprises heating at a temperature ranging from 25° C. to 70° C.

In any or all of the above embodiments, the reaction mixture is heated for a time period ranging from a time period greater than 0 minutes to a time period of 70 minutes.

In any or all of the above embodiments, the reaction mixture is heated for a time period ranging from a time period greater than 0 minutes to a time period of 40 minutes.

Also disclosed herein are embodiments of a method, comprising: combining a lithium-battery electrode active material and a lixiviant to provide a reaction mixture; heating the reaction mixture at a temperature ranging from 25° C. to 70° C.; and recovering lithium from the lithium-battery electrode active material in an amount of at least 60%, wherein the reaction mixture does not comprise an extraneous reducing agent.

In any or all of the above embodiments, the lixiviant is HBr.

In any or all of the above embodiments, the lixiviant is HI.

In any or all of the above embodiments, the reaction mixture is heated for a time period ranging from a time period greater than 0 minutes to a time period of 40 minutes.

Also disclosed herein is a method, comprising: discharging a lithium ion battery (LIB); dismantling the LIB to form a dismantled LIB; combining the dismantled LIB with NaOH to promote aluminum dissolution to thereby obtain an electrode active material; leaching at least one metal from the electrode active material to thereby obtain a pregnant leaching liquor, the leaching comprising combining a solid and liquid to form a reaction mixture having a S/L ratio ranging from an amount of greater than 0 g/L to an amount of 20 g/L, wherein the solid comprises an electrode active material, and wherein the liquid comprises at least one lixiviant, heating the reaction mixture, stirring the reaction mixture; and filtering the reaction mixture to separate any solid residue from the reaction mixture, which comprises at least one metal.

In any or all of the above embodiments, the method further comprises determining the elemental composition of the solid electrode active material to obtain a S/L ratio used for leaching.

### V. EXAMPLES

Materials—All commercial chemicals were used as received and handled in inert conditions unless stated otherwise. HI, ACS, 55-58% (Thomas Scientific) and HBr, 65% (Fisher Scientific) was used in the following examples. Cathode active material LiNiCoMnO₂ (Ni:Co:Mn=5:2:3) in powder (MTI Corporation) was used. All solutions were freshly prepared using deionized water (resistivity ≥18 MΩ·cm at 25° C.) (Millipore Direct-Q® 3 UV Water Purification System) was used. The examples were performed in flat bottomed flasks with heating accomplished using heating plates with stirring capabilities, wherein the stirring was achieved with magnetic stirrers.

Atomic Absorption Spectroscopy—Collected samples from the lithium recovery examples were analyzed by atomic absorption spectroscopy (AAS) using Perkin-Elmer 3030B Atomic Absorption Spectrophotometer.

Scanning Electron Microscopy—Scanning electron microscopy (SEM) using a Thermo Scientific™ Scios™ 2 FIB-SEM was conducted on the cathode active materials before and after leaching to illustrate observable changes resulting from the lixiviant treatment.

Diffusion Rate—The effect of concentration on the Li recovery can be explained by considering Fick's law of diffusion, which quantitively explains the diffusion rate, illustrated by Equation 2. Wherein

$$J = - D \frac{dC}{dx} \qquad ( Equation 2 )$$

Kinetic Analysis—Kinetic analysis offers mechanistic insights into the extraction process and thus an attempt to elucidate the kinetics associated with Li using leaching trials at various temperatures were systematically conducted. Elucidation on the rate-determining step was conducted using models defining the dissolution of a crystal structure, wherein Equations 3-5 correspond to the ash layer diffusion (boundary layer) control, Equation 6 corresponds to the chemical reaction control (chemical reaction at partial surface), Equation 7 corresponds to the parabolic product layer diffusion control, Equation 8 corresponds to Stoke's regime, and Equation 9 corresponds to the crystal dissolution. Wherein, k is the specific rate of reaction or rate constant, t is the time, and X is the fractional recovery. The experimental data was fitted into each of the above highlighted model equations (after linearization) to ascertain which model best described the lithium leaching kinetics for each lixiviant.

$$kt = 1 - 2 X / 3 - {( 1 - X )}^{2 / 3} \qquad ( Equation 3 )$$

$$k ln t = {[ 1 - {( 1 - X )}^{1 / 3} ]}^{2} \qquad ( Equation 4 )$$

$$kt = 1 - 3 {( 1 - X )}^{2 / 3} + 2 ( 1 - X ) \qquad ( Equation 5 )$$

$$kt = 1 - {( 1 - X )}^{1 / 3} \qquad ( Equation 6 )$$

$$kt = {X}^{2} \qquad ( Equation 7 )$$

$$kt = 1 - {( 1 - X )}^{2 / 3} \qquad ( Equation 8 )$$

$$kt = {[ - ln ( 1 - X ) ]}^{2 / 3} \qquad ( Equation 9 )$$

Equation 10 corresponds to the Arrhenius equation, where k denotes the rate constant, A is the pre-exponential factor, Eₐ is the activation energy, R is the ideal gas constant, and T is the temperature. The R² value indicates that most of the variability in the response variable is explained by the fitted model. The Arrhenius' equation was rearranged to obtain a linear form, the activation energies for the HBr and HI systems were determined by plotting ln (k) as a function of T⁻¹. Equation 11 corresponds to the re-arranged Arrhenius equation to obtain a linear form.

$$k = A \times {e}^{- {E}_{a} / RT} \qquad ( Equation 10 )$$

$$ln k = ln A - {E}_{A} / R 1 / T \qquad ( Equation 11 )$$

### Example 1

In this example, the desired solid to liquid (S/L) ratio was investigated and determined.

Different volumes of lixiviant were added to a fixed mass of 0.2 g of cathode active material comprising LiNiCoMnO₂ (Ni:Co:Mn=5:2:3) to give the different S/L ratios. Acid concentrations of 0.5 M were used, while the temperature was maintained at 25° C. Each experimental run was conducted for 40 minutes.

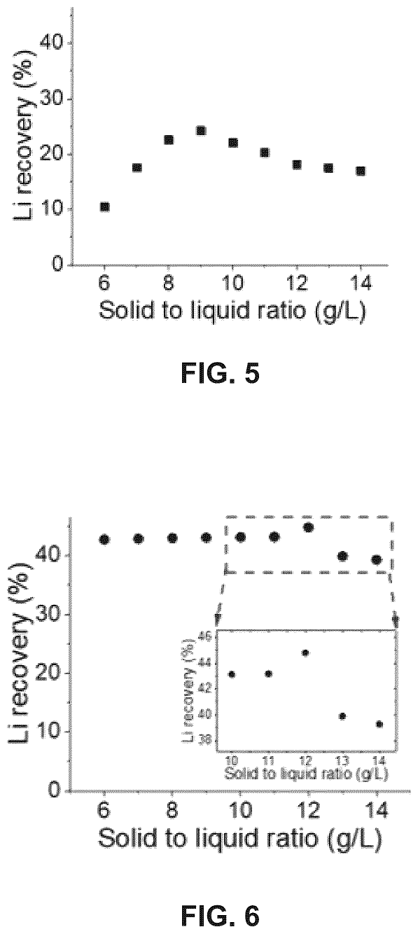

FIG. 5 depicts the results for HBr, and FIG. 6 depicts the HI S/L ratio. Both FIGS. 5-6 illustrate that Li recovery steadily increases with an increase in the S/L ratio until a maximum Li recovery is achieved. In these examples, a desired S/L ratio range for both HBr and HI was from 6 g/L to 14 g/L. In these examples, the increased Li recovery obtained using HBr employed a S/L ratio of 9 g/L, and the increased Li recovery using HI employed a S/L ratio of 12 g/L. It was determined that at a particular point, the S/L ratio reached a level wherein Li recovery began to decrease. This decrease in Li recovery while increasing the S/L ratio may be attributed to the mass transfer resistance and solid-liquid contact. For example, without being limited to a single theory, it currently is believed that an increase past the desired S/L ratio increases the mass transfer resistance at the solid/liquid interface, which in turn decreases the Li recovery. Moreover, the concentration gradient existing at the interface boundary can build up and thus slow down the constituent leaching kinetics from the bulk of the material, which results in a decrease in recovery. Additionally, an increase in the S/L ratio also decreases the amount of lixiviant present to react with the cathode active material per unit mass of cathode active material.

### Example 2

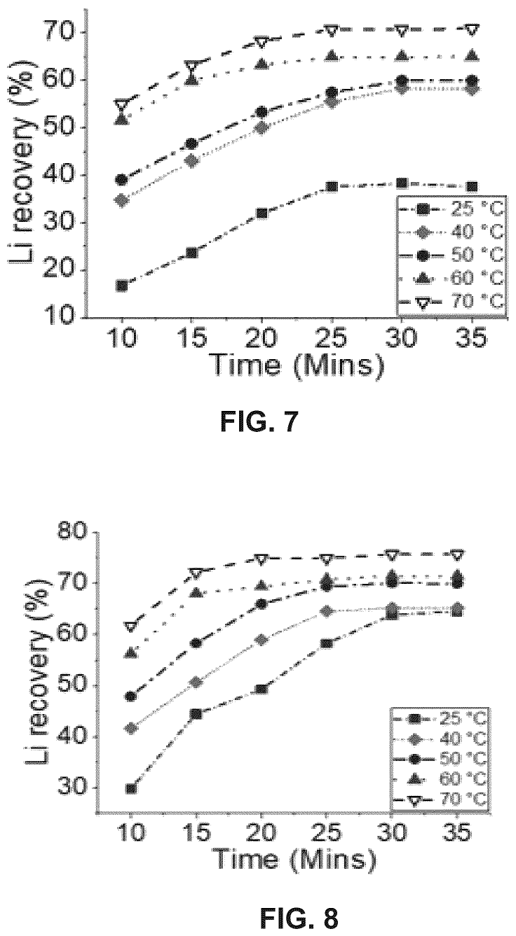

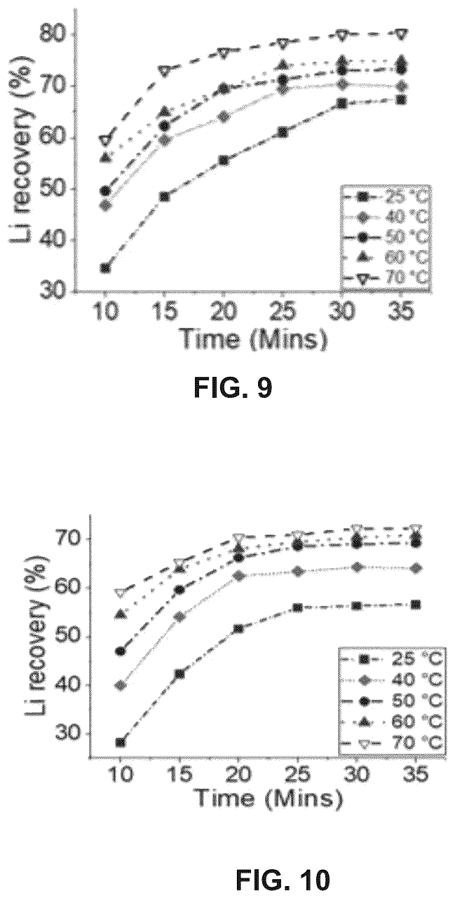

In this example, the lithium recovery was tested at temperature ranges 25° C. to 70° C. FIGS. 7-9 illustrate the Li recovery results that were obtained during the application of different HBr concentrations at different temperatures. The initial 25 minutes of contact time showed a minimal constant leaching rate for the lixiviant comprising HBr. The highest Li recovery for some of these examples was 80.3%, and was observed at a concentration of 3 M HBr after leaching for 30 minutes at 70° C. The highest Li recovery for other examples was 83.5% was achieved with an acid concentration of 2 M HI and at a temperature of 70° C.

The trend observed from the leaching data also illustrates that as the temperature increases so does the reaction rate constant, meaning that there is an increased propensity for the reaction to proceed to form the products. The rate constant can be a function of parameters such as ionic strength; however, it also depends on temperature as the rate constant can depend on temperature. Without being limited to a single theory, it currently is believed that increasing the temperature in turn increases the rate kinetics, which can result in superior Li recoveries at higher temperatures for the same lixiviant concentrations.

### Example 3

In this example, three concentrations for two different lixiviants were analyzed: 1 M HBr, 2 M HBr and 3 M HBr; and 1 M HI, 1.5 M HI, and 2 M HI. These concentrations were selected based on the relative strength of each acid in comparison to the conventionally utilized acids because with a high pKa value, the selected HI concentration range was narrower, meanwhile that of HBr was relatively broader than that of HI, but lower than the concentration used in conventionally used inorganic acids. The cathode active material was subjected to leaching at each of the specified concentrations with the applied temperature ranging from 25-70° C. Solution samples were initially collected after leaching for 10 minutes. Additional samples were subsequently collected at 5-minute intervals until maximum Li recovery was achieved for each leaching system (observed as 35 minutes for both systems).

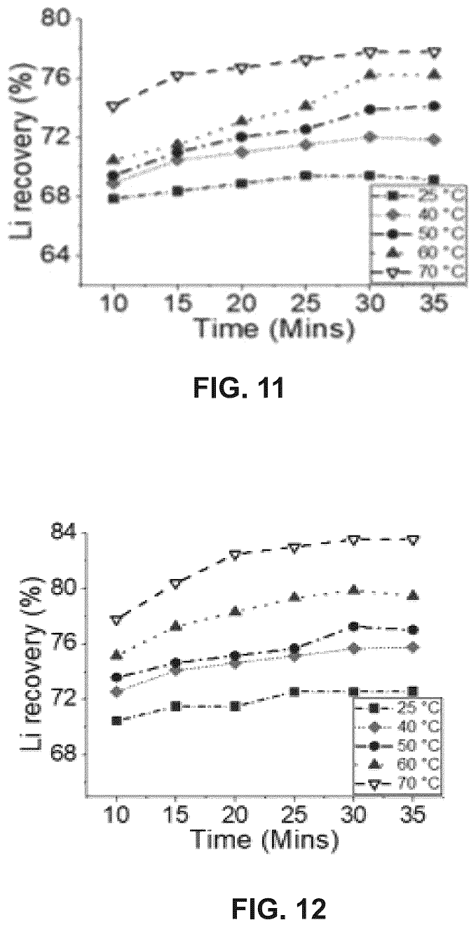

FIGS. 10-12 depict Li recoveries for the lixiviant comprising HI. FIGS. 10-12 illustrate a marked variation with superior Li recovery when increasing the concentration of the lixiviant comprising 1 M HI to 1.5 M HI. In contrast, the increase in Li recovery from 1.5 M HI to the 2 M HI system was less pronounced for some examples. In view of this, the present inventors determined that as lixiviant concentration increases, so did the concentration of H⁺, and hence determined lixiviant concentration can be used to better facilitate improved lithium recovery.

### Example 4

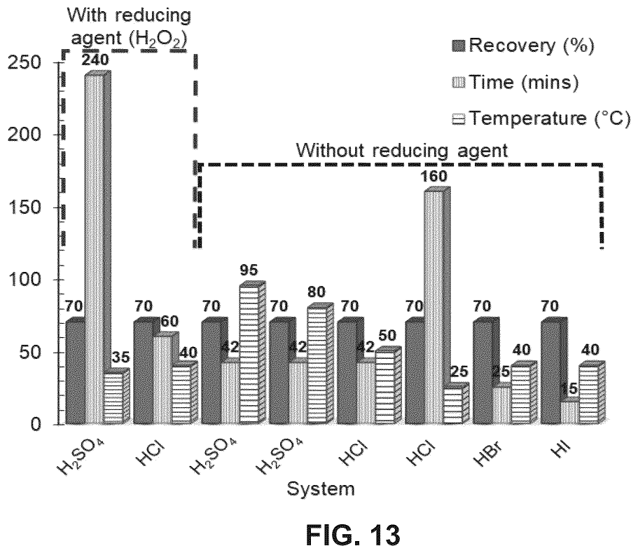

In this example, conventional acid leaching systems of H₂SO₄ and HCl were surveyed and compared to the Li recovery performance to that of lixiviants comprising HBr and HI. Representative conditions close to the operating conditions of the present disclosure were selected, in addition to a few additional extreme conditions for each of the two conventional acid systems. FIG. 13 depicts the survey data, which also is summarized in Table 3. A 70% Li recovery was selected as a representative threshold for comparison purposes, which corresponded to leaching at 40° C. for both the HBr and HI systems; however, the acid concentrations and leaching times differed. Moreover, with respect to FIG. 13, the HBr concentration that achieved the 70% recovery was double that of HI (3 M for HBr versus 1.5 M for HI) and the leaching time was almost double as well (25 minutes for HBr versus 15 minutes for HI). On considering the conventional lixiviants, H₂SO₄ and HCl, a 70% Li recovery was achieved by using 1 M H₂SO₄ in addition to an extraneous reducing agent at a slightly lower temperature of 35° C.; however, with a significantly longer leaching time of 240 minutes. A 3 M HCl system operating at 40° C. achieved a Li recovery of 70% with added reducing agent and after a leaching period of 57 minutes. This corresponded to leaching at 40° C. for both the HBr and HI systems; but, notably, the acid concentrations and leaching times differed. The HBr concentration that achieved the 70% recovery was double that of HI (3 M for HBr versus 1.5 M for HI) and the leaching time was almost double as well (25 minutes for HBr versus 15 minutes for HI).

TABLE 1

| | Leaching time | | |
|---|---|---|---|
| Lixiviant | (minutes) | Temperature | Li Recovery (%) |
| 1M H₂SO₄, 5% H₂O₂ | 240 | 35 | 70 |
| 1M H₂SO₄ | 42 | 95 | 70 |
| 18.4M H₂SO₄ | 42 | 80 | 70 |
| 1.75M HCl | 42 | 50 | 70 |
| 2M HCl | 160 | 25 | 70 |
| 3M HCl, 3% H₂O₂ | 57 | 40 | 70 |
| 3M HBr | 25 | 40 | 70 |
| 1.5M HI | 15 | 40 | 70 |

This example illustrates that lixiviants comprising HBr and HI are superior to conventional inorganic acid Li leaching systems not only because they give superior results without having to use an extraneous reducing agent, but they also can use a shorter leaching period corresponding to 2.8-16 times faster leaching kinetics. From a sustainability and/or cost standpoint, looking at the results (particularly HI) one can note that the option to increase the Li recovery by simply increasing the time for the extraction surpasses the Li extraction achieved by established processes such as the processes utilizing H₂SO₄ or HCl as the lixiviants.

### Example 5

In this example, the kinetics associated with Li leaching using HBr and HI were evaluated using leaching trials carried out at the various temperatures, ranging from 25° C. to 70° C. The leaching times were limited to 30 minutes, with maximum recovery being achieved during that period as earlier observed.

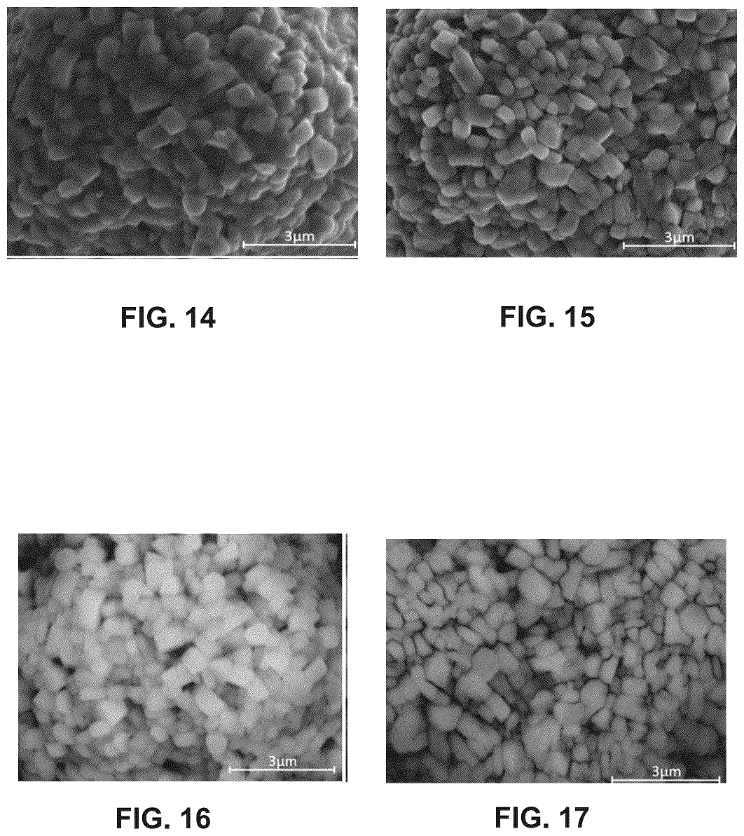

The shrinking core model was utilized (see FIG. 4), which divides the leaching reaction into the following steps: diffusion of lixiviant through the fluid-solid interface; diffusion of lixiviant molecules to the unreacted core surface through the fluid-solid interface and adsorption of the lixiviant molecules by unreacted solid; reaction of adsorbed lixiviant molecules with unreacted solid and product release; diffusion of reaction product to the solid-fluid interface through the reaction product ash layer; and diffusion of reaction product into the fluid. FIGS. 14-15 are the secondary electron (SE) images, wherein FIG. 14 is after the lixiviant application and FIG. 15 illustrates an untreated core. Comparison of FIG. 14 and FIG. 15 depict smaller sized grains after lixiviant application relative to the former untreated core. FIGS. 16-17 illustrate the contrast differences in a backscattered electron (BSE) image, which depict the presence of elements of different weights. FIG. 16 is the BSE image of the untreated cathode active material core, which shows a generally uniform bright contrast as there are more heavier elements uniformly distributed in the untreated cathode active material particle. FIG. 17 is the BSE image of the core after lixiviant application, which shows a more non-uniform and darker contrast which is a result of the heavier metals leaching out by lixiviant application.

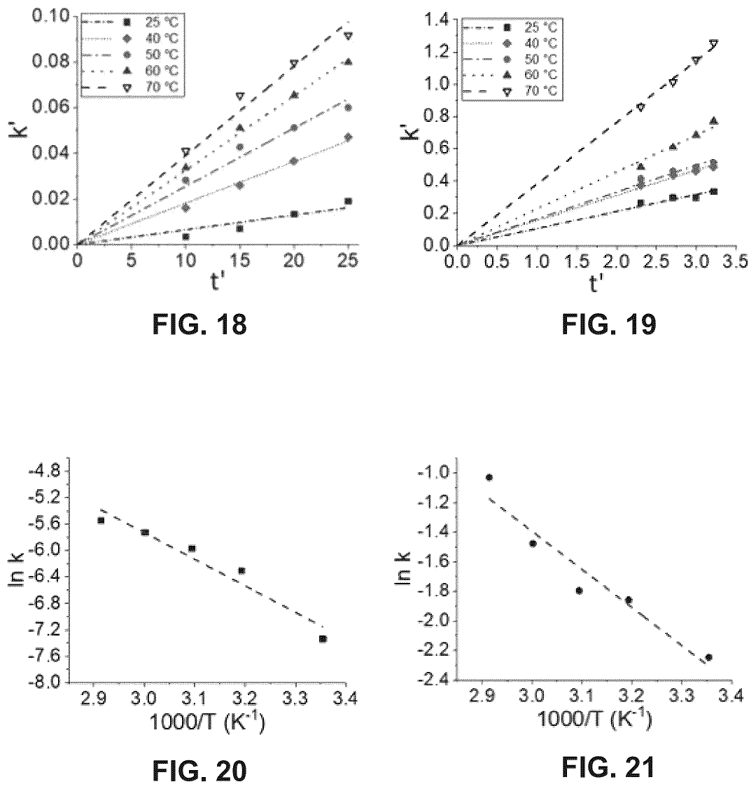

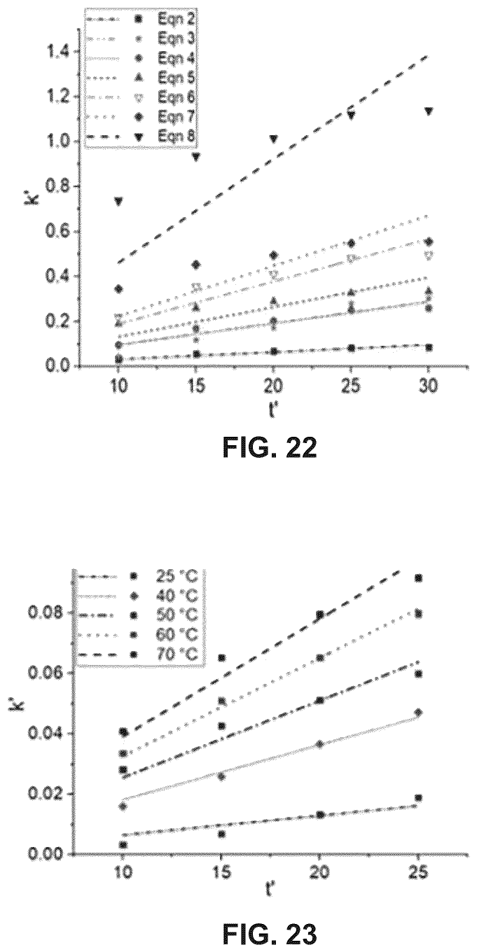

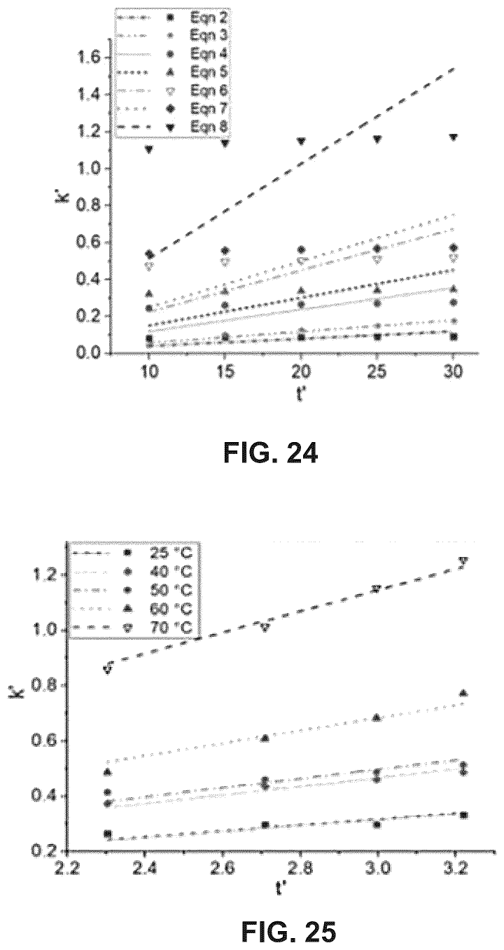

Using the data from leaching at different temperatures, kinetic plots were generated, which are illustrated in FIGS. 18-19. The HBr system shown in FIG. 18 indicates that lower temperatures fit the data best as compared to the higher temperatures since the value of the coefficient of determination (R²) is closest to 1 for the data fitted into the Arrhenius equation (see Equation 10). The HI system data represented by FIG. 19 shows no such trend, with intermediate and high temperatures presenting a good fit. Based on the obtained kinetic data, Li leaching for both systems can be surmised to be ash layer diffusion controlled. Elucidation on the rate-determining step was conducted using models defining the dissolution of a crystal structure, considering ash layer diffusion (boundary layer) control (see Equations 3-5); chemical reaction control (chemical reaction at partial surface) (see Equation 6); parabolic product layer diffusion control (see Equation 7); Stoke's regime (see Equation 8); and crystal dissolution (see Equation 9). The experimental data was fitted into each of the above model equations (after linearization) to ascertain which model best described the Li leaching kinetics for each lixiviant. The initial data fit for each acid was performed for the conditions given in Table 1 and the resulting plots are depicted in FIGS. 22-25. The HBr system data fits with Equation 3 as being most appropriate while the HI system data fit Equation 4. Thus, the Li dissolution process appears to be ash layer diffusion controlled in both the HBr and HI systems, which was established by fitting the data into the model equations derived from the shrinking core model and plots corresponding to the specific models were generated at various operating temperatures. These were used to obtain the different values of the diffusion rate constant (k) associated with the specific leaching process. Re-arranging Arrhenius' equation to obtain a linear form (see Equation 11), the activation energies for the HBr and HI systems were determined by plotting ln (k) as a function of T⁻¹ in FIGS. 20-21. The activation energies were determined as 33.49 KJ/mol and 21.43 KJ/mol for the HBr and HI systems respectively. The apparent activation energy associated with the HBr system was greater than that of the HI system. A greater activation energy translates to a higher energy barrier to be overcome by the reaction, meaning that it is more difficult for it to proceed.

### Example 6

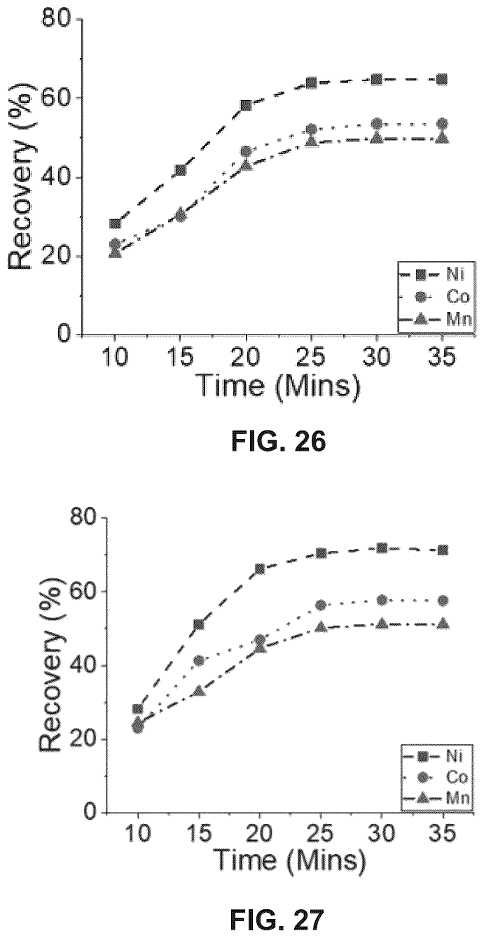

In this example, cathode active materials comprising Li, Ni, Co, and Mn were evaluated at the conditions identified from prior examples, which resulted in superior Li extraction for each lixiviant used (3 M HBr and 2 M HI, each at 70° C. and a leaching time of 30 mins). The resulting solid residues obtained after the solutions were filtered under the leaching conditions and were dissolved in aqua regia for 3 hours and analyzed for metal content. FIGS. 26-27 illustrate Ni, Co, and Mn recoveries at the conditions for highest Li recovery. FIG. 26 illustrates the conditions for highest Li recovery for lixiviant comprising HBr. FIG. 27 illustrates the conditions for the highest Li recovery for lixiviant comprising HI. The average percentage of metals retained in the solid residues after leaching operations are given in Table 2.

TABLE 2

Metal Retained in Residues (%)

| Metal | HBr | HI |
|---|---|---|
| Li | 17.3 | 13.6 |
| Ni | 33.3 | 26.1 |
| Co | 45.1 | 39.1 |
| Mn | 48.6 | 47.0 |

A mass balance around each of the metals illustrated that each of the metals were accounted for within 3% error margin which could have been due to losses resulting during the various stages of the process. FIGS. 26-27 depicts that of the three metals, Ni recovery was the highest when using both HBr and HI as the lixiviant. When the lixiviant comprised HBr, the maximum recovery was 64.8%; and when the lixiviant comprised HI, the maximum recovery was 71.9%. The recoveries of the other metals in the HBr and HI systems were: 53.5% and 57.8% for Co and 49.8% and 51.2% for Mn, respectively. This example establishes that lixiviants comprising HBr and Hi are equally competitive in recovering other Li-battery constituents, relative to established inorganic acid systems.

In view of the many possible embodiments to which the principles of the present disclosure may be applied, it should be recognized that the illustrated embodiments are only preferred examples of the present disclosure and should not be taken as limiting the scope of the present disclosure. Rather, the scope of the present disclosure is defined by the following claims. We therefore claim as our present disclosure all that comes within the scope and spirit of these claims.

We claim:

1. A method, comprising:
combining (i) a solid comprising an electrode active material and (ii) a liquid comprising a lixiviant having a pKa ranging from −12 to −8 to form a reaction mixture having a solid-to-liquid (S/L) ratio ranging from an amount greater than 0 g/L to an amount 20 g/L;
heating the reaction mixture;
stirring the reaction mixture; and
isolating a pregnant leach liquor from the reaction mixture, wherein the pregnant leach liquor comprises at least one metal.

2. The method of claim 1, wherein the lixiviant has a concentration ranging from greater than 0 M to 4 M.

3. The method of claim 2, wherein the lixiviant is HBr or HI.

4. The method of claim 1, wherein the reaction mixture has an S/L ratio ranging from 5 g/L to 15 g/L.

5. The method of claim 1, wherein the electrode active material comprises a lithium-containing material.

6. The method of claim 5, wherein the lithium-containing material further comprises Co, O, Fe, P, Ni, Mn, Al, or any combination thereof.

7. The method of claim 1, wherein the at least one metal is an alkali metal.

8. The method of claim 7, wherein the alkali metal is Li.

9. The method of claim 1, wherein the at least one metal is a transition metal.

10. The method of claim 9, wherein the transitional metal is Ni, Co, Mn, or any combination thereof.

11. The method of claim 1, wherein heating the reaction mixture comprises heating at a temperature ranging from 25° C. to 70° C.

12. The method of claim 1, wherein the reaction mixture is heated for a time period ranging from greater than 0 minutes to 70 minutes.

13. A method, comprising:
combining a lithium-battery electrode active material and a lixiviant to provide a reaction mixture;
heating the reaction mixture at a temperature ranging from 25° C. to 70° C.; and
recovering lithium from the lithium-battery electrode active material in an amount of at least 60%, wherein the reaction mixture does not comprise an extraneous reducing agent.

14. The method of claim 13, wherein the lixiviant has a pKa ranging from −12 to −8.

15. The method of claim 14, wherein the lixiviant is HBr or HI.

16. The method of claim 13, wherein the reaction mixture is heated for a time period ranging from greater than 0 minutes to 40 minutes.

17. A method, comprising:
discharging a lithium ion battery (LIB);
dismantling the LIB to form a dismantled LIB;
combining the dismantled LIB with NaOH to promote aluminum dissolution to thereby obtain an electrode active material;
leaching at least one metal from the electrode active material to thereby obtain a pregnant leaching liquor, the leaching, comprising
(i) combining a solid and liquid to form a reaction mixture having a S/L ratio ranging from an amount greater than 0 g/L to an amount of 20 g/L, wherein the solid comprises an electrode active material, and wherein the liquid comprises at least one lixiviant;
(ii) heating the reaction mixture;
(iii) stirring the reaction mixture; and
(iv) filtering the reaction mixture to separate any solid residue from the reaction mixture.

18. The method of claim 17, further comprising determining an elemental composition of the solid electrode active material to obtain a S/L ratio used for leaching.

19. The method of claim 18, wherein the elemental composition comprises Li, Ni, Mn, Co, Al, Fe, or any combination thereof.

20. The method of claim 17, further comprising treating the pregnant leaching liquor for cathode metal separation.
